(19) United States
(12) Patent Application Publication
(10) Pub. No.: US 2012/0050523 A1
(43) Pub. Date: Mar. 1, 2012

(54) METHOD OF INSPECTING AN OPTICAL FIBER JUNCTION

(76) Inventors: Ian D. Cook, Wilmington, NC (US); Igor Rafaelyevich Mejouev, Wilmington, NC (US); Michael Seifert, Wilmington, NC (US); Larry B. Stansell, Wilmington, NC (US)

(21) Appl. No.: 13/214,597

(22) Filed: Aug. 22, 2011

Related U.S. Application Data
(60) Provisional application No. 61/378,560, filed on Aug. 31, 2010.

(51) Int. Cl. H04N 7/18

(52) U.S. Cl. 348/92; 348/E07.085

(57) ABSTRACT

A system and method of inspecting an optical fiber junction is provided. The method includes moving an optical fiber having a junction, a recoat portion overlaying the junction and non-recoat portions on opposite sides of the recoat portion through an imaging region imaged by a pair of cameras. The optical fiber is imaged to acquire a plurality of images with the cameras as the optical fiber continuously moves through a distance to capture images of the recoat portion and the non-recoat portions adjacent to the recoat portion. The plurality of acquired images are evaluated for potential imperfections, and an output is provided indicative of detected images having potential imperfections.

### CROSS-REFERENCE TO RELATED APPLICATIONS

This application claims the benefit of priority under 35 U.S.C. §119 of U.S. Provisional Application Ser. No. 61/378,560, filed on Aug. 31, 2010, the content of which is relied upon and incorporated herein by reference in its entirety.

### BACKGROUND

The present invention generally relates to the inspection of optical fiber, and more particularly relates to a method of inspecting an optical fiber junction or splice following fiber splicing and recoating.

Optical fibers are typically formed during a drawing process and have a practical limitation on the length of each drawn fiber. Fibers are typically connected together to provide a longer length of fiber and to achieve dispersion managed fiber. This is typically achieved by removing a coating at the terminating ends of the fibers to be joined and splicing the fiber ends together with a welding process, such as fusion splicing, to form a connecting junction. The fiber-to-fiber splice is then recoated over the splice connection to complete the junction. The handling of the fiber during the splicing process can lead to potential damage of the optical fiber. To detect any potential damage, the spliced fiber junction is typically inspected manually with the use of a microscope following the splicing process. The conventional manual inspection process is tedious, time-consuming, and labor intensive, and typically occurs prior to loading the fiber onto a winder such that damage may occur during the loading of the fiber on the winder which may go undetected.

### SUMMARY

According to one embodiment, a method of inspecting an optical fiber junction is provided. The method includes the step of moving optical fiber having a junction, a recoat portion overlaying the junction and non-recoat portions on opposite sides of the recoat portion through an imaging region imaged by at least one camera. The method also includes the step of imaging the optical fiber to acquire a plurality of images with the at least one camera as the optical fiber moves through a distance to capture images of the recoat portion and non-recoat portions adjacent to the recoat portion. The method further includes the step of evaluating each of a plurality of acquired images of the optical fiber from the recoat portion and the non-recoat portions to detect images having potential imperfections. The method further includes the step of providing an output indicative of detected images having potential imperfections.

According to another embodiment, a method of inspecting an optical fiber junction having a recoat thereon is provided. The method includes the step of moving an optical fiber having a junction and a recoat portion covering the junction through an imaging region imaged by at least one camera. The method also includes the step of imaging the optical fiber to acquire a plurality of images with the at least one camera as the optical fiber continuously moves through a distance to capture images of the optical fiber. The method further includes the step of evaluating each of a plurality of acquired images of the optical fiber to detect images having potential imperfections. The method further includes the step of providing an output indicative of detected images having potential imperfections.

Additional features and advantages will be set forth in the detailed description which follows, and in part will be readily apparent to those skilled in the art from that description or recognized by practicing the embodiments as described herein, including the detailed description which follows, the claims, as well as the appended drawings.

It is to be understood that both the foregoing general description and the following detailed description are merely exemplary, and are intended to provide an overview or framework to understanding the nature and character of the claims. The accompanying drawings are included to provide a further understanding, and are incorporated in and constitute a part of this specification. The drawings illustrate one or more embodiments, and together with the description serve to explain principles and operation of the various embodiments.

### BRIEF DESCRIPTION OF THE DRAWINGS

FIG. 1 is a side view of an optical fiber inspection system for inspecting a fiber junction as the fiber is wound on a winder, according to one embodiment;

FIG. 2 is a side view of a length of optical fiber to be inspected with the fiber inspection system;

FIG. 3 is an enlarged view of a portion of the optical fiber of FIG. 2 showing the fiber splice and recoat portion;

FIG. 4 is an elevated perspective view of the fiber inspection system shown in FIG. 1;

FIG. 5 is a front view of the fiber inspection system shown in FIG. 4;

FIG. 6 is an enlarged view of a portion of the fiber inspection system further illustrating the inspection of optical fiber;

FIG. 7 is a sectional view of section VII of FIG. 6;

FIG. 8 is a block diagram further illustrating the optical fiber inspection system;

FIG. 9 is a block/flow diagram illustrating the splice inspection process, according to one embodiment;

FIG. 10 is a block/flow diagram illustrating the splice analyzer-image processing routine, according to one embodiment;

FIG. 11 is a block/flow diagram further illustrating the splice analyzer and review/pass-fail mode routine, according to one embodiment;

FIG. 12 is a flow diagram illustrating the frame analysis processing routine for the image processing, according to one embodiment;

FIG. 13 is a flow diagram further illustrating the inspection processing routine, according to one embodiment; and

FIG. 14 is a screen shot taken from a display monitor of the output of the inspection system illustrating the inspection outputs, according to one embodiment.

### DETAILED DESCRIPTION

Reference will now be made in detail to the present preferred embodiments, examples of which are illustrated in the accompanying drawings. Whenever possible, the same reference numerals will be used throughout the drawings to refer to the same or like parts.

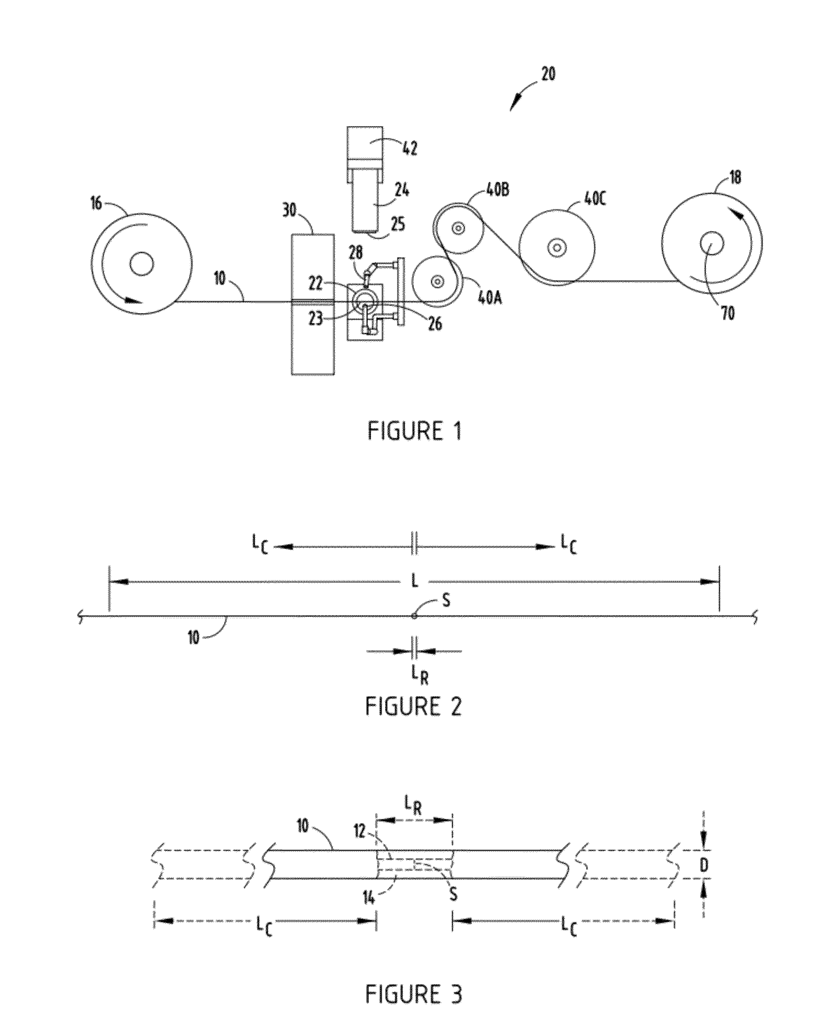

The optical fiber inspection system and method inspects an optical fiber splice or junction with the use of one or more cameras and image processing to detect imperfections in the recoat region and adjacent non-recoat regions of the fiber. Embodiments of the inspection system and method are herein disclosed in connection with the drawing FIGS. 1-14, wherein like numbers indicate the same or corresponding elements throughout the drawings. The phrase “coated optical fiber” as used herein means an optical fiber drawn from a preform and applied with a protective polymer coating layer to its outer surface. “Recoat region” as used herein means the protective cover layer reapplied over a fiber splice after the initial protective coating was removed. The phrase “non-recoat region” as used herein means the optical fiber having its original protective coating layer not subjected to removal or recoating during the splicing operation. The coated optical fiber may have any of various sizes and colors. The inspection system and method provides enhanced and efficient inspection of the fiber junction and detects imperfections which may be caused by damage afflicted to the fiber recoat region as well as the fiber non-recoat regions on either side of the recoat region.

Referring to FIGS. 1-3, a spliced optical fiber 10 and an inspection system 20 for inspecting the spliced optical fiber 10 is generally shown, according to one embodiment. The optical fiber 10 is wound onto two reels, namely a payout reel 16 and a take-up reel 18. The reels 16 and 18 are assembled to a fiber winder 70 which winds the optical fiber 10 onto the take-up reel 18 from the payout reel 16. The reels 16 and 18 are located on opposite sides of the inspection system 20 and the optical fiber 10 is inserted therein such that it passes through the inspection system 20. At the input side of the inspection system 20 is the payout reel 16 for providing coated optical fiber that is wound thereof and through the inspection system 20 and output onto the take-up reel 18. It should be appreciated that the payout reel 16 and the take-up reel 18 may each be provided with optical fiber 10 having a terminal end of the fiber to be joined prior to the splicing process, whereby the terminal ends are processed during the splicing process by removing a portion of coating layer at each terminal end, fusion splicing the exposed ends of the uncoated fibers 12 together to form a splice S, and recoating the uncoated area surrounding the splice S so as to provide the recoat portion 14. According to one example, the recoat portion 14 of the fiber 10 may have a length L_{R} of about one centimeter (1 cm).

The inspection system 20 may be located in a splicing clean room integrated with or close to a winder or winding machine 70 for inspecting the optical fiber junction and adjacent portions when the fiber 10 is wound onto the take-up reel 18 and ready for shipment to customers, such that any damage prior to shipment can be detected. The optical fiber 10 extending between reels 16 and 18 is loaded into the inspection system 20 such that a desired length L to be inspected is positioned to pass through the inspection system 20 as the optical fiber 10 is wound up on the take-up reel 18. As seen in FIGS. 2 and 3, the inspection length L of the fiber 10 to be inspected includes the recoat portion 14 of length L_{R} in the vicinity of the splice and non-recoat portions of length L_{C} on both sides of the recoat portion 14. According to one embodiment, the inspection length L is greater than 1 meter, more preferably greater than 3 meters, and most preferably about 7 meters. According to a specific embodiment, the inspection length L includes a recoat length L_{R} of about 1 centimeter and two non-recoat portion each having a length L_{C} of about 3.6 meters, providing for a total length L of just over 7 meters of fiber to be inspected.

It should be appreciated that the inspection system 20 continuously moves the optical fiber 10 of the inspection length L through the inspection system 20 at a rate of about 17 seconds per meter of optical fiber. In one example, about 7 meters of optical fiber 10 continuously passes through the inspection system 20 during the inspection process of a time period of about 120 seconds. The inspection system 20 advantageously detects defects not only at the splice but also at the non-recoat portions which typically are handled during the splicing operation and may be subjected to damage which may not otherwise be detected. When the image acquisition of the inspection process is off, the winder 70 may advance the winding of the optical fiber 10 onto the take-up reel 18 at a faster speed.

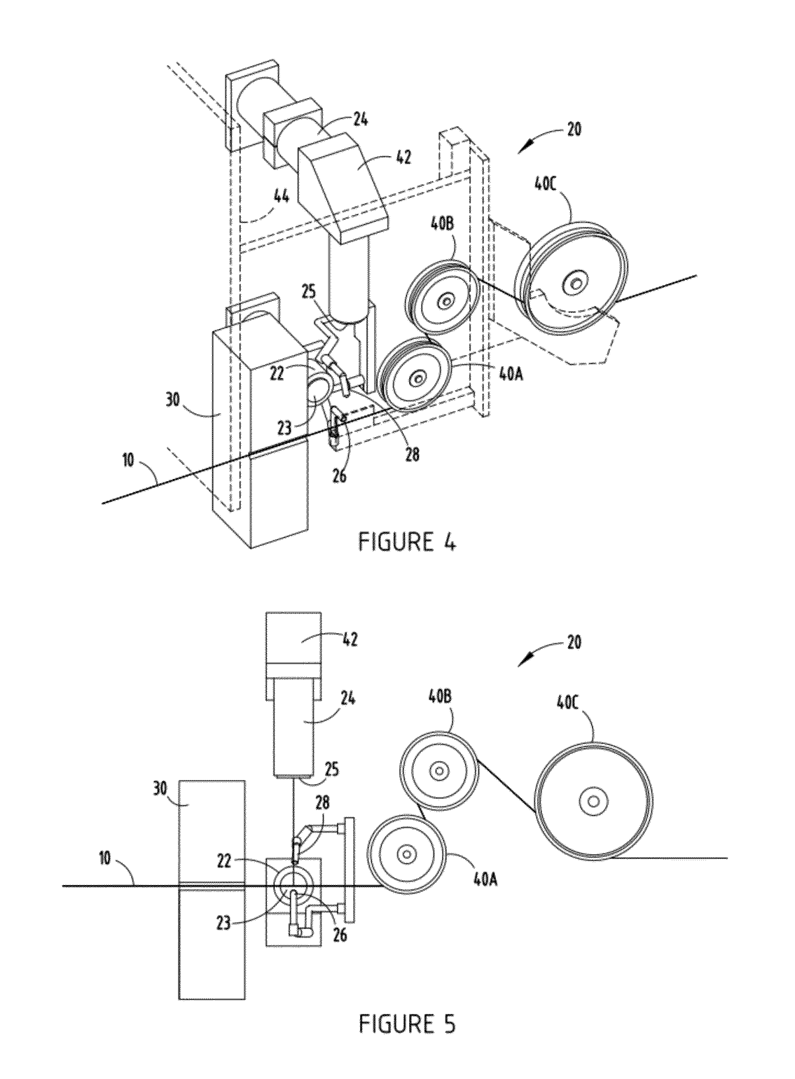

With particular reference to FIGS. 4-7, the inspection system 20 includes at least one camera connected to a mounting structure 44 for generating a plurality of images of optical fiber 10 passing through an imaging region 60. In the embodiment shown, the inspection system 20 includes first and second high-speed cameras 22 and 24 mounted to mounting structure 44 and arranged to capture images orthogonal (90°) relative to each other. The first camera 22 is shown oriented to capture images along a first imaging axis 32 generally shown extending along a horizontal axis. The second camera 24 is aligned pointing in a horizontal direction onto a reflector 42 which, in turn, reflects the second imaging axis 34 vertically downward, such that the first and second imaging axes 32 and 34 are orthogonal to each other. It should further be appreciated that the first camera 22 may include an optical focus lens 23, and the second camera 24 may include an optical focus lens 25 for focusing the acquired optical images of the optical fiber 10. Each of the first and second cameras 22 and 24 are high-speed cameras capable of capturing over a thousand (1,000) digital images of the optical fiber 10 as it continuously passes through the inspection length L, and more particularly taking approximately fourteen thousand (14,426) images over an inspection length L of approximately 7 meters, for a total of 28,852 images, according to one embodiment. Images acquired with the first and second cameras 22 and 24 are stored and indexed such that pairs of images acquired by the first and second cameras 22 and 24 at the same point in time may be matched and compared to each other. Thus, cameras 22 and 24 generate fourteen thousand (14,426) pairs of images in one given example that are stored in memory and processed, according to one embodiment. The at least one camera generates at least 1,000 images as the optical fiber 10 is moved by inspection length L, and more preferably at least 5,000 images, and most preferably at least 10,000 images.

The inspection system 20 includes a fiber movement assembly which, in one embodiment, includes the take-up reel 18 moved by the winder 70 to pull the optical fiber 10 through the inspection system 20. Also included are pulleys 40A-40C which guide the optical fiber 10 along its path through the inspection system 20 and onto the take-up reel 18. Pulleys 40A-40C may provide a desired tension as the optical fiber 10 is continuously passed through the imaging region 60 of the cameras 22 and 24 during the generation of the plurality of images.

The inspection system 20 further includes a flaw detector 30 shown and described herein as an optical fiber diameter sensor for sensing the outer diameter of the optical fiber 10. The diameter sensor 30 monitors the diameter of the optical fiber 10 as it passes therethrough to detect changes in the diameter of the optical fiber 10 which may be indicative of damage to the coating layer. The flaw detector 30 therefore provides a secondary check for defects in the form of deviations in the diameter of the optical fiber 10 passing through the inspection system 20.

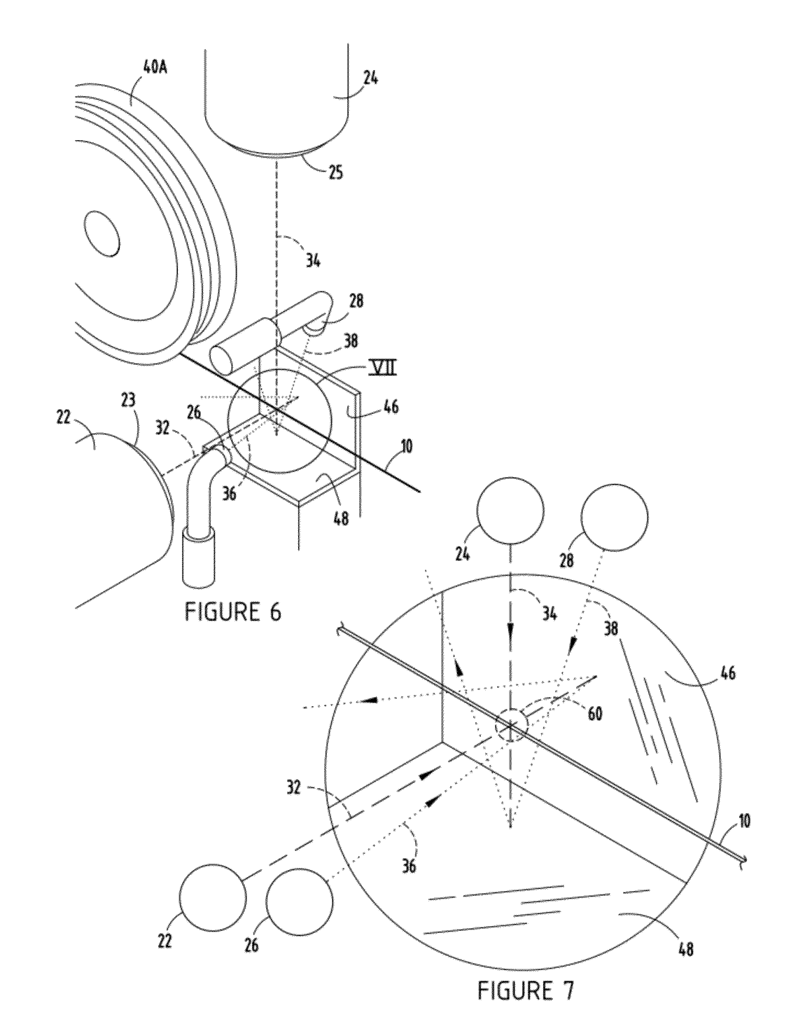

Inspection system 20 further includes a pair of light illuminators 26 and 28, each configured to provide a source of light illumination to the optical fiber 10 to be inspected at the imaging region 60 in relation to the first and second cameras 22 and 24. As seen in FIGS. 6 and 7, the first light illuminator 26 provides light illumination focused onto the optical fiber 10 in a generally horizontal direction along first light axis 36, and the second light illuminator 28 provides light illumination onto the optical fiber 10 in a generally vertical direction along second light axis 38. An inspection backing plate having horizontal and vertical walls 46 and 48 each with a reflecting surface are provided as background to the optical fiber 10 relative to the first and second cameras 22 and 24 and first and second light sources 26 and 28. The vertical backing surface 46 has a reflective surface that reflects light illumination on first light axis 36 from the first light source 26 such that the light illumination reflects off from surface 46 at an angle that does not interfere with the first imaging axis 32 of the first camera 22. Similarly, the horizontal backing surface 48 has a reflective surface that reflects light on second light axis 38 from the second light source 28 at an angle such that the light does not interfere with the second imaging axis 34 of the second camera 24. The first light illuminator 26 may be oriented at an angle in a range between 10° to 80° relative to the first imaging axis 32 of the first camera 22, according to one embodiment. Similarly, the second light illuminator 28 may be oriented at an angle in the range between 10° to 80° relative to the second imaging axis 34 of the second camera 24, according to one embodiment. Additionally, it should be appreciated that surfaces 46 and 48 may include a concave curvature. Further, a grid pattern may be provided on surfaces 46 and 48 to improve fiber edge detection in images that contain very light colored fibers.

The optical fiber inspection system 20 performs image acquisition and recording of acquired images, processes the stored images with image processing, and evaluates the stored images to determine which images to output to a user (operator). During the image acquisition, the image inspection machine 50 acquires images at a very high speed, such as 100 images per second, and the acquired images are recorded from both cameras into the storage medium, which may include two hard drives on the image inspection machine 50. The image acquisition and recording process may be performed without real time image processing, as this process is to record over 28,000 images without interruption with a uniform time stamp step. After the image recording is completed, the image inspection machine 50 starts the image processing according to one embodiment. The imaging processing synchronizes (pairs) image IDs from both cameras by checking the time stamp of each image and creating the index file (index map) that has pair IDs and corresponding image IDs from each camera. Additionally, each image in the pair is further processed to assign weight to it, and records the weighted values into the index file.

After the image processing is completed and the index file is created, the controller 90 may open a new instance of image processing which does not read all saved images, but instead just opens the index file (index map) to graphically display the index map to an operator. The controller 90 also checks relations between pairs without opening images, but if it detects a suspicious zone of pairs in the index map it uses pointers (frame IDs) saved in the index map to read particular pairs of raw saved images from the image storage (hard drives) to reprocess them again and display to an operator as a thumbnail that is color coded in the display using yellow and red dots and arrows. Whenever an operator selects the pair by clicking on any small square in the graphical map or by clicking on the thumbnail of suspicious pairs, or by browsing through any sequence of pairs, the system may read image IDs of the pairs selected, and may go to the image storage (hard drive) and read a pair of raw images, reanalyzes them again, displays them in raw grayscale and in color scale with yellow and red dots. This approach allows flexibility in testing and implementation of new algorithms for reviewing the already stored archived images.

According to one embodiment, some limited number of analyzed suspicious images that were selected to present to an operator are saved in the special folder as four images in one image including a pair of initial grayscale images and a pair of processed and analyzed blue images with yellow and red dots. This helps to control the system sensitivity at the time of review and also to control the operator accuracy. This also allows fast post review of selected defects or imperfections without running image processing software. This further helps to create an image library of defects.

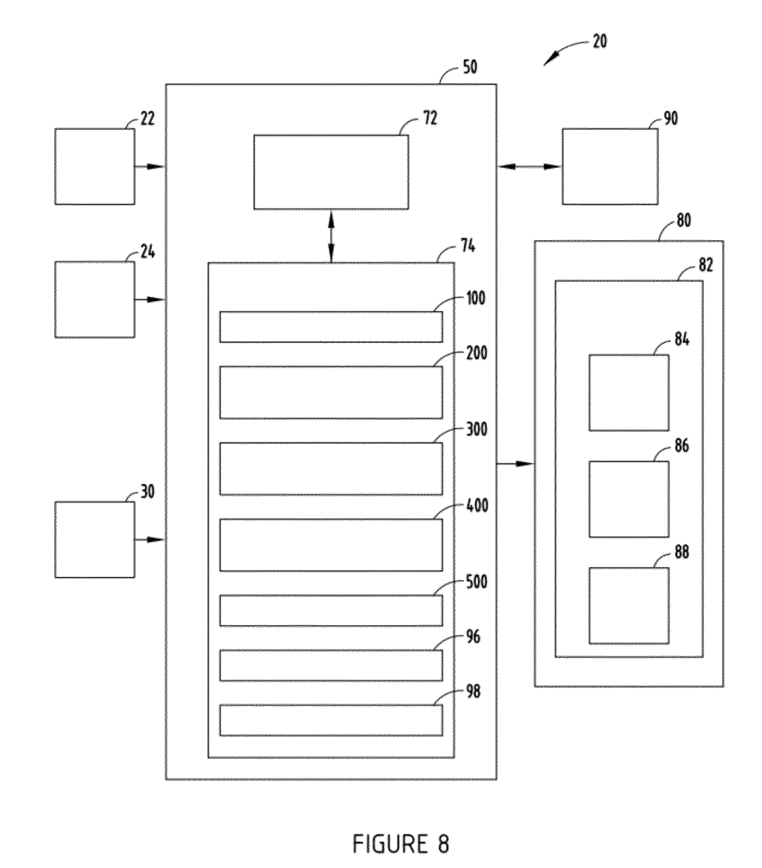

Referring to FIG. 8, the inspection system 20 is generally illustrated having an image inspection controller 50 coupled to the first and second cameras 22 and 24 for evaluating the plurality of images acquired from the cameras 22 and 24 and determining potential imperfections in the optical fiber. The image inspection controller 50 includes an image processor, such as a microprocessor 72 and memory 74. It should be appreciated that any digital and/or analog processing circuitry may be employed to process various routines and data, according to various embodiments. The memory 74 may include volatile and non-volatile memory storage such as random access memory (RAM), electronically erasable programmable read-only memory (EEPROM), flash memory, and other known memory storage medium. The image processor 72 evaluates the images of the optical fiber 10 collected from both the recoat portion of the optical fiber and adjacent non-recoat portions as the optical fiber continuously moves through the imaging region of the cameras. The image processor 72 processes each individual image captured by the first and second cameras 22 and 24, compares pairs of images captured at the same time with the first and second cameras 22 and 24, normalizes the images, detects anomalies, such as edges indicative of potential imperfections in each image, assigns a weighted value to each image, assigns weighted values to pairs of images and successive image defects, and stores all acquired images and weighted values in memory 74. Thus, the evaluation of the images including detecting anomalies in each image and weighting or ranking each image based on the detected anomalies, and the output is provided based on the weighted images. The image processor 72 processes the images, inspection processing routines and generates an output which may be presented to a display 80, such as a video monitor. On the display 80, an operator of the inspection system 20 may view a splice analyzer screen 82 which may include providing the output fiber map 84, the most relevant images 86 of the optical fiber junction and the non-recoat regions detected as having potential imperfections, and a selected pair of images 88. The display 80 may include other indicators of a splice analyzer screen 82 and may be controlled by an operator using a human machine interface.

The image inspection controller 50 processes various routines with the image processor 72 that are stored in memory 74. Stored in memory 74 is a splice inspection process routine 100, a splice analyzer-image processing routine 200, a splice analyzer in review/pass-fail mode routine 300, a frame analysis processing routine 400, and an inspection processing routine 500. In addition, various anomalies 96 indicative of potential imperfections, such as edges are stored in memory 74 for execution by certain routines. Also stored in memory 74 are the various stored images 98 that are captured with the first and second cameras 22 and 24. The images may be stored and indexed in memory 74 and indexed as pairs taken at the same point in time. The stored images may also be assigned weights that are also stored in memory 74.

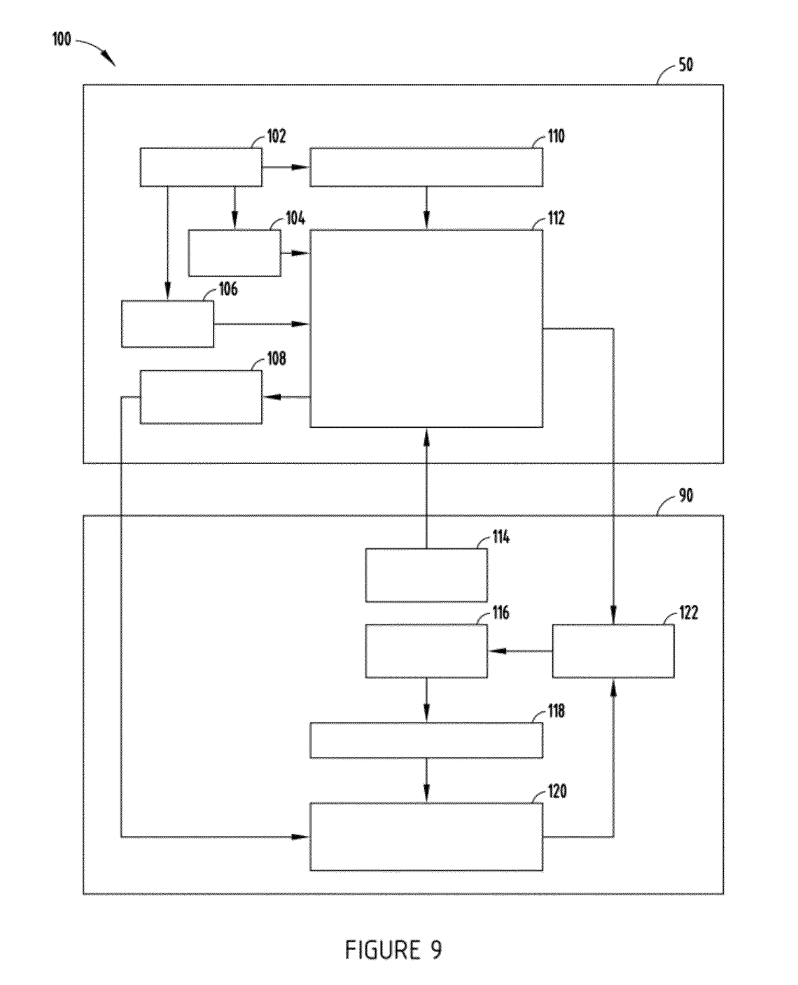

Referring to FIG. 9, the image inspection controller 50 is shown in relation to a winder controller 90 which is integrally coupled thereto and operated therewith. The winder controller 90 may control the operation of the fiber winder and its use in conjunction with the image inspection controller 50 for performing fiber inspection and winding operations. The winder controller 90 may include a microprocessor and memory or other conventional controller and includes a flaw data file 114 which stores the flaw data from the flaw detector and makes it available for the image inspection controller 50. Additionally, winder controller 90 has wind machine controls 116 which perform the various controls of the winder. A command line is provided in block 118 to start the review, and the splice analyzer is set in review mode on the wind machine in block 120. The winder controller 90 may control the speed of the winder such as to wind the optical fiber at a high speed when the inspection process is not performed, and to slow down to an inspection speed during the image acquisition process of the inspection process. Winder controller 90 includes a status file 122 which keeps track of the status of the inspection process such that the winder may be controlled accordingly.

The image inspection controller 50 is shown having the image recording block 102 providing vertical images 104 and horizontal images 106 in corresponding databases. The image inspection controller 50 has a command line to start the analysis at block 110 and the splice analyzer is set in an analyzing mode on the video machine at block 112. The splice analyzer may analyze the splices from the vertical and horizontal images in the image pairs and provide an index file or index database 108 which is made available to the winder controller 90.

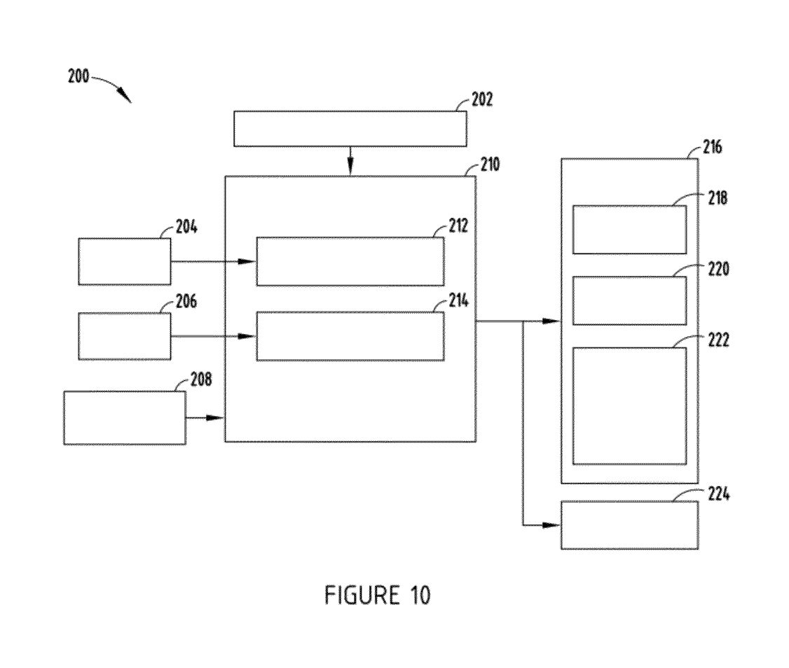

Referring to FIG. 10, the splice analyzer-image processing routine 200 is illustrated, according to one embodiment. Routine 200 includes step 202 of issuing a command line to start the analysis and a splice analyzer 210 which includes framer analyzers 212 and 214 that may perform frame analyzer frame-by-frame analysis for each of the vertical images 204 and horizontal images 206 stored in memory. Additionally, the flaw data file 208 is made available to the splice analyzer 210. The frame analyzers 212 and 214 may provide a frame-by-frame analysis in search of anomalies in the optical fiber during the inspection process. An index file 216 is made available to store current settings 218, flaw detector data (flaw position and diameter) 220, and frame-by-frame data 222, such as offset, average color, error and other data. Additionally, a status file 224 is made available to provide the status of the splice analysis which may be communicated to the winder controller.

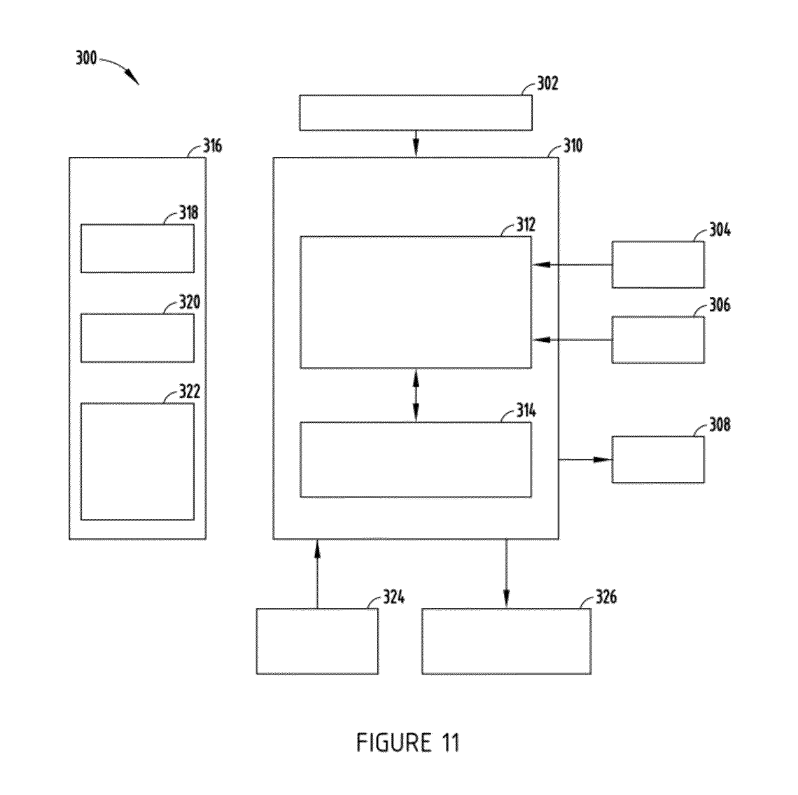

The splice analyzer in review/pass-fail mode routine 300 is illustrated in FIG. 11, according to one embodiment. Routine 300 includes step 302 of issuing a command line to start the analysis and proceeding to a splice analyzer 310 which may include a frame analyzer 312 to provide frame analysis such as only requested/suspicious selected frames may be analyzed, according to one embodiment. The frame analyzer 312 receives the vertical images 304 and horizontal images 306 and provides the frame analysis for the requested suspicious selected frames analysis. Additionally, a visualization engine 314 is included in the splice analyzer 310 for providing frame browser, frame viewers, and a suspicious frames library. The visualization engine 314 may interact with an operator input 324 to allow the operator to select visual outputs. The suspicious and flaw frames images may be stored in an archive at step 326. The splice analyzer 310 receives an index file 316 having current settings 318, flaw data 320 and the frame-by-frame data 322 including offset, average color, and error count. The visualization engine 314 may provide a status file output 308 which may be made available to the winder machine.

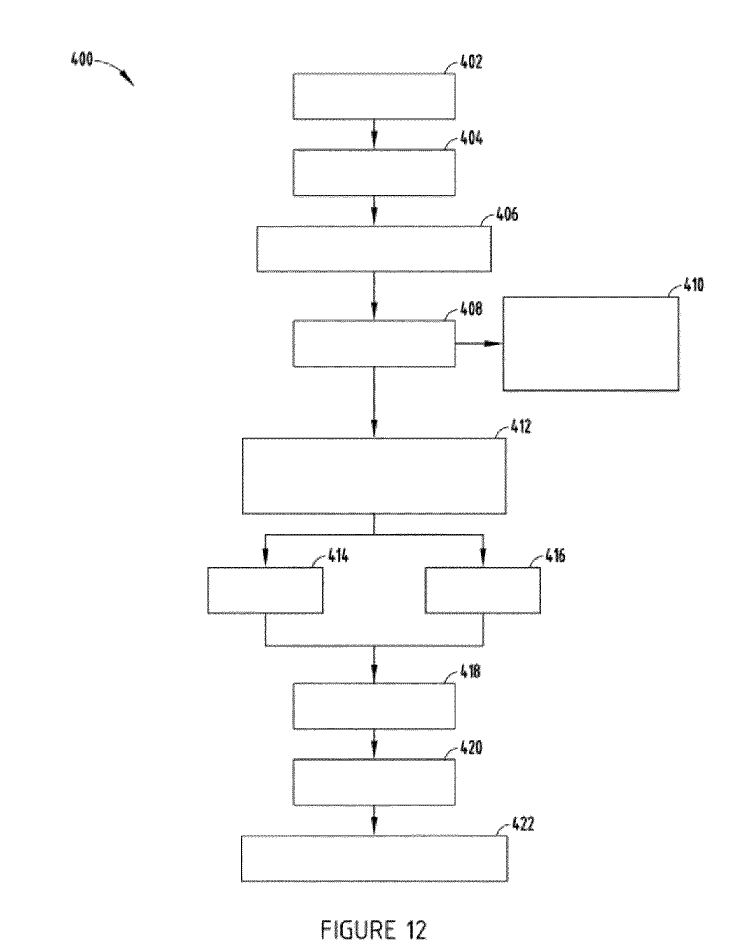

The frame analysis processing routine 400 is illustrated in FIG. 12, according to one embodiment. Routine 400 includes step 402 of acquiring the image frame of the image data, and an edge detector 404 of detecting edges of the fiber. It should be appreciated that known image processing edge detection techniques may be employed. Step 406 includes a fiber image extraction and tilting into matrix for removing tilt of the image of the fiber and provides a fiber image matrix at step 408. Additionally, step 410 provides dedusting for the removal of non-fiber (non-moving) defects from the image.

Routine 400 includes step 412 of providing lighting (round shape) normalization and thresholds calculation(s). In doing so, a pair of synchronized images from both cameras is provided as raw grayscale images. Routine 400 may subtract a cylindrical geometry of a known optical fiber from the image to provide variations between a known optical fiber and the imaged fiber which may include potential imperfections. The normalization may normalize shading such that if the image is more dark than light in color, the intensity of the shading may be rescaled. Accordingly, the inspection system may operate more effectively with variations in color in the optical fiber. The grayscale images may be reprocessed to provide colored images. The coloring may give an indicator of the analysis processed. The vertical medium intensity distribution across the fiber may be calculated using the cylindrical profile. A small gradient of intensity may be detected along the fiber. The intensity of each pixel may be recalculated to normalize the fiber image by removing vertical cylindrical gradients and small horizontal gradients. The fiber image or matrix may appear as very flat-blue processed portions of fiber images, according to one embodiment.

Next, routine 400 proceeds to perform a horizontal convolution at step 414 and a vertical convolution at step 416. The convolution process steps may detect some gradients in the reprocessed images which may be shown as “yellow dots” (binary 1 after threshold application), according to one embodiment. As a result of the initial convolution process, the Boolean gradient matrix 418 is created, having “yellow” dots as 1 and 0 in the rest positions. If the “yellow” dots count in the matrix is small, a low weight, such as zero is assigned to the image. If the count of the “yellow” dots on a given image is large enough, the system performs cleaning and checks for clustering. Step 420 of cleaning and clustering the yellow dots, performs a cleaning to purge single “noise” dots and thin lines of dots (caused by image noise and recoat sanding process) from the matrix. If the count of the “yellow” dots after cleaning still remains large enough for a given image, then clustering is performed to search clustered dots. If the clustered “yellow” dots are detected, a higher weight is assigned to the image. Clustered dots may be shown as “red” dots on the visual image. At step 422, an error count is provided to assign a weight to each image based on the image imperfections detection.

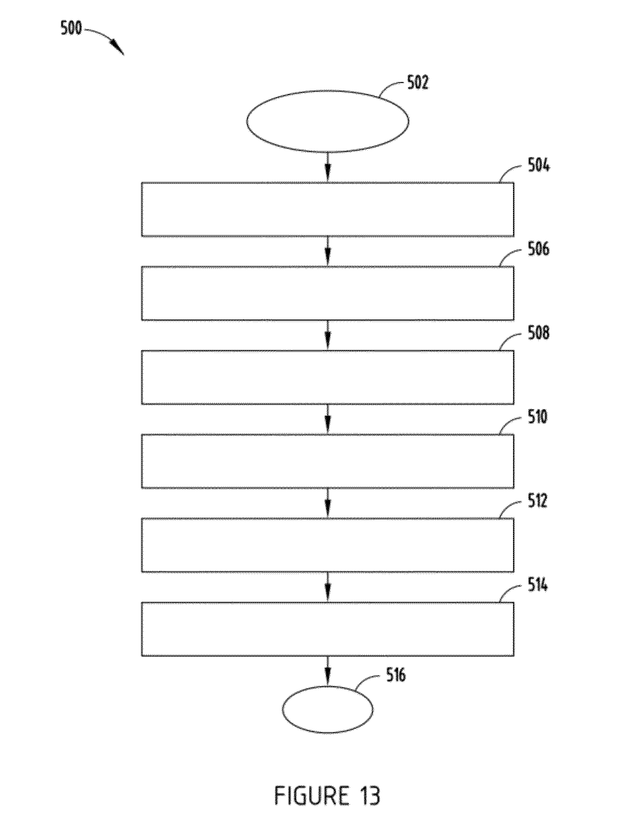

Referring to FIG. 13, the inspection processing routine 500 is illustrated, according to one embodiment. Inspection processing routine 500 begins at step 502 and proceeds to step 504 to arrange images generated from both the first and second cameras to create a linear images' map. In doing so, the image processor arranges the images or indexes of the inspected piece of optical fiber. Next, at step 506, routine 500 groups the images from both the first and second cameras in pairs based on a time stamp. By knowing the time stamp, corresponding images acquired at the same time with the first and second cameras can be grouped in pairs such that the cameras are capturing images of the same location on the fiber from orthogonal directions. Each pair of images represents a bi-directional image of the optical fiber in a particular linear position.

Routine 500 then proceeds to step 508 to assign a weight of defect probability to each image. An example of a linear images map and assigned weights of defect probability for a series of image is shown in Table 1 below, according to one example of a spliced fiber inspection.

TABLE 1
Index Map of Spliced Area with Weighted Values

| Pair ID | 1510 | 1511 | 1512 | 1513 | 1514 | 1515 | 1516 | 1517 |
|---|---|---|---|---|---|---|---|---|
| Camera 1 | 1253 | 1254 | 1255 | 1256 | 1257 | 1258 | 1259 | 1260 |
| Image ID | | | | | | | | |
| Camera 1 | 0 | 11 | 7 | 15 | 10 | 3 | 0 | 0 |
| Image | | | | | | | | |
| Weight | | | | | | | | |
| Camera 2 | 1378 | 1379 | 1380 | 1381 | 1382 | 1383 | 1384 | 1385 |
| Image ID | | | | | | | | |
| Camera 2 | 0 | 0 | 23 | 2 | 9 | 17 | 3 | 0 |
| Image | | | | | | | | |
| Weight | | | | | | | | |
| Zone of | | | | Select | | | | |
| Interest | | | | this | | | | |
| | | | | pair to | | | | |
| | | | | display | | | | |

Each of the first and second cameras, labeled Camera 1 and Camera 2, is assigned a unique frame number (pointer to the image), such as frames 1253-1260 for Camera 1 and frames 1378-1385 for Camera 2. A weight value corresponding to each camera frame number is provided therebelow. Each pair of camera frames has an associated pair ID number shown as numbers 1510-1517 in the given example. The image weight assigned to each image may be based on image imperfections. For example, the weight may be based on a gradient of 500 points clustered in some region with a detection of noise indicative of a crack or bubble or other potential imperfection of the optical fiber. Each image is assigned a weighted value based on the weighted criteria.

After the index map has been created and the defect probability weights assigned to each image, routine 500 proceeds to step 510 to analyze the pair-to-pair weight distributions and relations to define zones of interest. The zones of interest may be clustered weight zones along the inspected fiber length. At step 512, routine 500 selects the most significant pairs from each zone, and at step 514 displays the selected most significant pairs as an output to an operator such as on a monitor or display. An example of the selection of a most significant pair(s) is illustrated in the last row of Table 1. In this example, the zone of interest is ID 1511-1515 and a selected pair is pair ID 1513. The selected pair 1513 is displayed to an operator, and an operator can browse the video frames pair by pair in both directions starting from pair ID 1513 to make decisions as to whether to fail a defect in the zone or to move to the next zone. The operator can jump to the next zone of interest for further review without scrolling through all insignificant images between zones. Before proceeding to the next splice, the operator may be presented with all image pairs selected for review.

When selecting the most significant pairs of frames, the routine 500 may make the selection based on the center of the distribution, according to one embodiment. According to another embodiment, the selected zone of interest may be selected based on a sum total of the weighted values of the pair of images by selecting the greatest combined weighted value. The images selected for display to an operator may be arranged based on the weighted values or the combined weighted values of the pairs, according to one embodiment. According to another embodiment, the display of the selected pairs may be based on sequential frames capture by showing the most significant or center pair first and then showing successive adjacent images. Routine 500 returns or ends at step 516. The inspection system advantageously detects potential imperfections such as bubbles and cracks that may exist in the recoat portion and in the adjacent non-recoat portions. By having overlapping images, the length of the zone of interest can vary according to the nature of the defect. Long horizontal scratches in the fiber coating can create long zones. The inspection system 20 may select at least one pair of frames for a zone to display to the operator. Selected zones representing pairs can be arranged for review according to sequential position or according to severity of defects in each.

Some zones can be created and some pairs can be assigned to such zones of interest based not only on image weight of defect probability but also on data receipt from other fiber defect detectors, such as the flaw detector, by knowing linear distance from the other detector to the cameras and the inspection speed. The system 20 may select an image pair to review for the operator in the fiber position corresponding to the other detector alert signal(s).

The pair ID directly corresponds to linear position of the suspicious zones and can be used not only for flexible navigation among a large number of images but also for detecting sources of defects. For example, repeated occurrences of interest zones and some range of pair IDs can indicate some rough edges on a piece of equipment on the splicing bench. As image sequences and index maps remain stored in the inspection system for extended periods of time, they could easily be reviewed at a later time from many defect positions and also reprocessed in case of change of image analyzing algorithms.

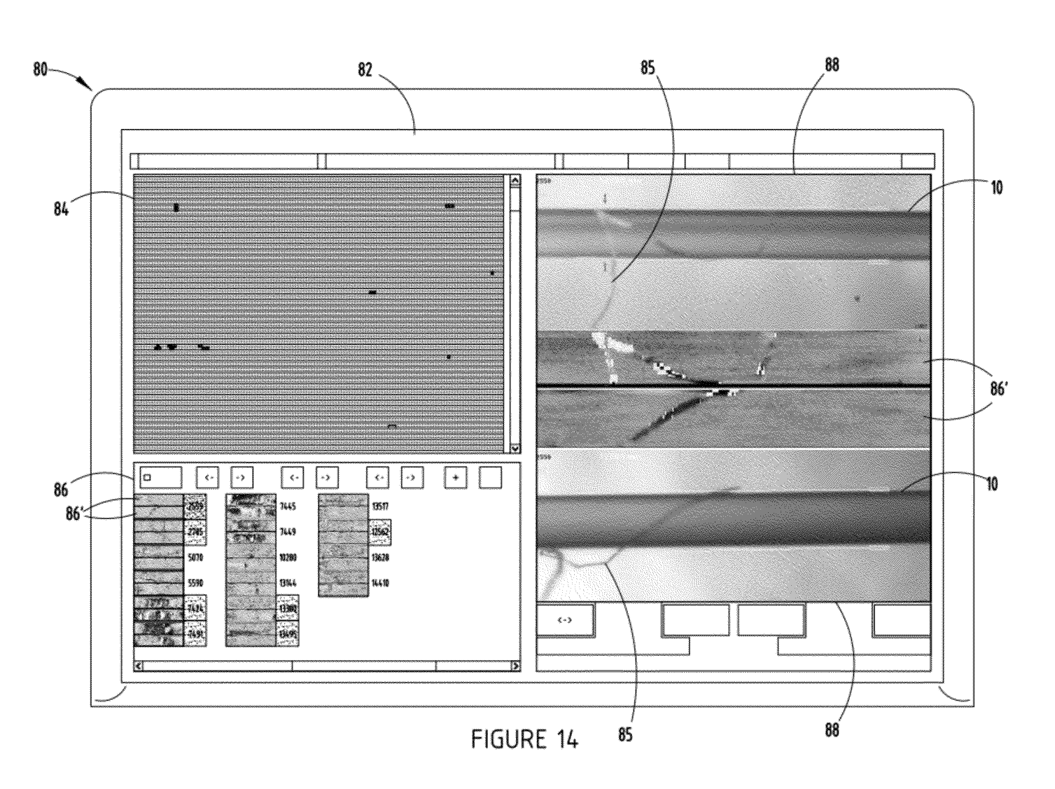

Referring to FIG. 14, one example of a screen shot taken from the display showing outputs of the inspection system is illustrated. The display 80 presents a splice analyzer screen 82 with outputs from the processed routines and image data to present the operator with selected images of most significance for review. In this example, the splice analyzer screen 82 presents a fiber map 84 which includes rows of rectangular boxes which represent successive pairs of images captured throughout the inspection process over about a 7 meter inspection length L of optical fiber centered about the splice. The rectangular boxes generally include a color code such as a green color when the assigned weight of the images is relatively low, and a more severe color, such as yellow, when a higher weight value is assigned to the image pair, and a red weight when a clustered image is presented. A cluster of higher weighted images present in a given pair will result in a red output on the display. Consecutive pairs of images extend linearly in rows which extend one row after another. The double square representations of the image pairs are sequential representing images 0.5 millimeters apart along the fiber in the given example. If the square is green, then the weight of the image is 0, if it is a yellow, orange or red color then the pair has something in it that should be reviewed by an operator. Some yellow boxes are grouped to mean the same defect could be seen in several overlapping pairs or it could be an extended defect, such as a long crack.

In this example, 28,852 images were taken for this junction, generating 14,426 pairs of images. Out of this large amount of image data, the system selects an assigned weight greater than 0 up to 49 images, but in this example presented the operator with 16 images for review as shown in the selected image pairs window 86 on the lower left of the screen 82 showing the color coded version of the images 86′. The selected image pairs are then graphically presented on the right side of the screen 82 which shows the color coded version 86′ of the first and second camera images 88 and the corresponding grayscale images 88. The images 88 shown are of the shaded rectangular boxes seen in the upper left corner of fiber map 84. An operator may use the human machine interface buttons to move left or right, up or down amongst the pairs. In the example shown, a fiber 10 as seen in both grayscale and color coded images is shown with a foreign object that is determined to be debris 85. An operator may inspect the pair of images and determine that it is debris and make a decision that no defect is present. If a defect is determined by the operator, the operator can initiate the resplicing of the junction which would be followed by re-inspection with the inspection system 20.

Accordingly, it should be appreciated that the inspection system 20 advantageously provides for a high speed real time inspection process for inspecting optical fiber 10 at the splice over the recoat portion and adjacent non-recoat portions. The inspection system 20 and method provides for an accurate inspection process that is efficient in time and labor and capable of detecting defects all the way through the winding process, prior to delivery of fiber to a customer. The inspection system 20 may advantageously inspect the optical fiber 10 and wind the optical fiber 10 onto a reel with the winder at the final stages of the manufacturing facility.

It will be apparent to those skilled in the art that various modifications and variations can be made without departing from the spirit or scope of the claims.

What is claimed is:

1. A method of inspecting an optical fiber junction having a recoat thereon comprising:
moving optical fiber having a junction, a recoat portion overlaying the junction and non-recoat portions on opposite sides of the recoat portion through an imaging region imaged by at least one camera;
imaging the optical fiber to acquire a plurality of images with the at least one camera as the optical fiber moves through a distance to capture images of the recoat portion and non-recoat portions adjacent to the recoat portion;
evaluating each of a plurality of acquired images of the optical fiber from the recoat portion and the non-recoat portions to detect images having potential imperfections; and
providing an output indicative of detected images having potential imperfections.

2. The method of claim 1, wherein the optical fiber is continuously moved through the imaging region as the camera captures images of the optical fiber.

3. The method of claim 1, wherein the step of evaluating each of the plurality of images comprises evaluating the plurality of images collected during movement of the optical fiber by a distance greater than one meter.

4. The method of claim 3, wherein the method of evaluating each of the plurality of images comprises evaluating the plurality of images collected during movement of the optical fiber by a distance of greater than three meters.

5. The method of claim 1, wherein the step of imaging the optical fiber comprises generating a first plurality of images on a first imaging axis with a first camera and generating a second plurality of images on a second imaging axis with a second camera, wherein the first and second axes are not parallel.

6. The method of claim 1, wherein the at least one camera generates greater than 1,000 images as the optical fiber is moved by the distance.

7. The method of claim 1, wherein the step of evaluating the plurality of images comprises detecting anomalies in each image and weighting each image based on the detected anomalies, wherein the step of providing an output provides the output based on the weighted images.

8. The method of claim 1 further comprising the step of applying light illumination to the optical fiber and a light reflecting surface backing the fiber in the imaging region with one or more light sources oriented at an angle in the range between 10° to 80° relative to an imaging axis of the at least one camera.

9. The method of claim 1, wherein the step of moving the optical fiber comprises moving the optical fiber with a winder onto a take-up spool.

10. The method of claim 1, wherein the output comprises a monitor for displaying the detected images having potential imperfections based on image weighting.

11. A method of inspecting an optical fiber junction having a recoat thereon comprising:
moving optical fiber having a junction and a recoat portion covering the junction through an imaging region imaged by at least one camera;
imaging the optical fiber to acquire a plurality of images with the at least one camera as the optical fiber continuously moves through a distance to capture images of the optical fiber;
evaluating each of a plurality of acquired images of the optical fiber to detect images having potential imperfections; and
providing an output indicative of detected images having potential imperfections.

12. The method of claim 11, wherein the step of imaging the optical fiber comprises acquiring a plurality of images of the recoat portion of the optical fiber and non-recoat portions adjacent to the recoat portion, and wherein the step of evaluating each of the plurality of acquired images comprises evaluating each image of the optical fiber from the recoat portion and the non-recoat portions.

13. The method of claim 11, wherein the step of evaluating each of the plurality of images comprises evaluating images collected as the optical fiber moves by a distance greater than one meter.

14. The method of claim 13, wherein the method of evaluating each of the plurality of images comprises evaluating images collected as the optical fiber moves by a distance of greater than three meters.

15. The method of claim 11, wherein the step of imaging the optical fiber comprises generating a first plurality of images on a first imaging axis with a first camera and generating a second plurality of images on a second imaging axis with a second camera, wherein the first and second imaging axes are not parallel.

16. The method of claim 11, wherein the at least one camera generates greater than 1,000 images as the optical fiber moves through the distance.

17. The method of claim 11, wherein the step of evaluating the plurality of images comprises detecting anomalies in each image and weighting each image based on the detected anomalies, wherein the step of providing an output provides the output based on the weighted images.

18. The method of claim 11 further comprising the step of applying light illumination to the optical fiber and a light reflecting surface backing the fiber in the imaging region with the one or more light sources oriented at an angle in the range between 10° to 80° relative to an imaging axis of the at least one camera.

19. The method of claim 11, wherein the step of moving the optical fiber comprises moving the optical fiber with a winder onto a take-up spool.

20. The method of claim 11, wherein the output comprises a monitor for displaying the detected images having potential imperfections based on image weighting.
